(19) United States
(12) Patent Application Publication
(10) Pub. No.: US 2007/0067156 A1
(43) Pub. Date: Mar. 22, 2007

(54) Recording medium for recording automatic word spacing program

(75) Inventor: Seong-Bae Park, Buk-du (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/471,334

(22) Filed: Jun. 20, 2006

(30) Foreign Application Priority Data
Aug. 30, 2005 (KR) P2005-79904

(51) Int. Cl. G06F 17/27

(52) U.S. Cl. 704/9

(57) ABSTRACT

Disclosed is a recording medium for recording an automatic word spacing program for a short message. The recording medium includes a learning module and a classification module. The learning module creates a rule database by using a rule-based learning model, and creates an error case library by using a memory-based learning model. The classification module is installed in a mobile terminal together with the rule database and error case library, which have been created by the learning module, so as to perform an automatic word spacing operation with respect to a short message by the mobile terminal before the short message is output through a display unit. The automatic word spacing program is constructed with a combination of the rule-based learning model and memory-based learning model, and can thus be efficiently used in mobile terminals, which have a small-quantity memory and a limited calculation capability.

This application claims the benefit under 35 U.S.C. 119(a) of an application entitled “Recording Medium For Recording Automatic Word Spacing Program” filed in the Korean Intellectual Property Office on Aug. 30, 2005 and assigned Serial No. 2005-79904, the entire contents of which are incorporated herein by reference.

### BACKGROUND OF THE INVENTION

1. Field of the Invention

The present invention relates to an automatic word spacing method for short messages received by a mobile terminal and a recording medium for recording a program for the method, and more particularly to an automatic word spacing method which employs the combination of a rule-based learning algorithm and a memory-based learning algorithm.

2. Description of the Related Art

Recently, due to the increase in the use of mobile terminals, the use of short message service (SMS) messages through mobile terminals is also increasing. The length of an SMS message is limited to 160 bytes by protocol, so that a maximum of 80 Korean syllables can be transmitted through one SMS message because one Korean syllable uses two bytes. In addition, since one Korean word generally includes three to four syllables, about 20 to 27 spaces must be used among the 80 syllables which can be transmitted at a time. Accordingly, when word spacing is appropriately performed, about 60 Korean syllables can be transmitted at a time. In the English language, English letters occupy 1 byte per letter, so that a maximum of 160 letters can be transmitted through one SMS message. In using English, 20 to 27 spaces may be used.

This labor-intensive process of simple word spacing, which cannot input characters having meaning, not only reduces the number of maximum transmissible characters but also requires a user to do a cumbersome job of pressing multiple keys.

In order to avoid such a problem, many users often write messages without spaces. Then, because proper word spacing is not used, the legibility of the SMS message for the person who has received the SMS message is degraded.

Meanwhile, since the conventional automatic sentence spacing systems are designed to operate by a computer or server, the systems require a large amount of data or a morpheme analyzer, so that it is impossible to apply such a system to a mobile terminal equipped with a small-capacity memory.

### SUMMARY OF THE INVENTION

Accordingly, the present invention has been made to solve the above-mentioned problems occurring in the prior art, and an object of the present invention is to provide an automatic word spacing method for short messages, which employs a combination of a rule-based learning algorithm and a memory-based learning algorithm and can thus be installed and executed in a device which has a small-capacity memory and a limited calculation capability.

Another object of the present invention is to provide a recording medium for recording a program implementing the above-mentioned automatic word spacing method.

To accomplish these objects, in accordance with one aspect of the present invention, there is provided a recording medium including a rule database for storing word spacing rules which are applied to each word included in a short message; an error case library for storing error cases, to which the word spacing rules of the rule database are not applied, and word spacing rules to be applied to the error cases; and an automatic word spacing program for a short message, the program performing an automatic word spacing operation with respect to each word of a received short message using the rule database and the error case library. The automatic word spacing program for a short message includes a method to be sequentially executed for each word included in the short message, the method including attempting to apply the word spacing rules of the rule database in order with respect to each word of the short message until a word spacing rule applicable to a corresponding word is found; applying the word spacing rule found from the rule database to the corresponding word; retrieving an error case most similar to the corresponding word, to which the word spacing rule has been applied, from the error case library; calculating a similarity degree between the corresponding word and the retrieved error case; and retrieving a word spacing rule corresponding to the error case with respect to the corresponding word from the error case library when the similarity degree is equal to or greater than a predetermined reference value, and applying the retrieved word spacing rule to the corresponding word.

Preferably, the recording medium is installed in a mobile terminal so as to perform an automatic word spacing operation with respect to a short message received by the mobile terminal and then to display the short message on a display unit.

In accordance with another aspect of the present invention, there is provided a recording medium for recording an automatic word spacing program, the recording medium including a learning module for creating word spacing rules using a predetermined word group, creating a rule database for storing the created rules, and constructing an error case library by extracting an error case using the rule database and creating a word spacing rule to be applied to each error case; and a classification module for performing an automatic word spacing operation with respect to a series of words by using the rule database and error case library, which are created by the learning module.

Preferably, the classification module sequentially performs the steps of attempting to apply the word spacing rules of the rule database in order with respect to each word in a series of words until a word spacing rule applicable to each word is found; applying a word spacing rule found from the rule database to a corresponding word; extracting an error case most similar to the corresponding word from the error case library; calculating a similarity degree between the corresponding word and the extracted error case; and retrieving a word spacing rule corresponding to the error case from the error case library when the similarity degree is equal to or greater than a predetermined reference value, and applying the retrieved word spacing rule to the corresponding word.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of an entire automatic word spacing program according to the present invention;

FIG. 2 is a flowchart illustrating the operation of a learning module in the automatic word spacing program according to the present invention;

FIG. 3 illustrates a program obtained by coding a learning module in the automatic word spacing program according to the present invention;

FIG. 4 is a flowchart illustrating the operation of a classification module in the automatic word spacing program according to the present invention;

FIG. 5 illustrates a program obtained by coding a classification module in the automatic word spacing program according to the present invention;

FIG. 6 is a graph illustrating the accuracies of algorithms as a function of sentence lengths so as to verify the effect of the automatic word spacing program according to the present invention;

FIG. 7 illustrates examples of rules for Korean, which are learned by the modified-IREP;

FIG. 8 is a graph illustrating the number of rules created according to the algorithms as a function of sentence lengths so as to verify the effect of the automatic word spacing program according to the present invention; and

FIG. 9 illustrates information gains of nine syllables with respect to a training set and an error case library according to the present invention.

### DETAILED DESCRIPTION OF THE PREFERRED EMBODIMENT

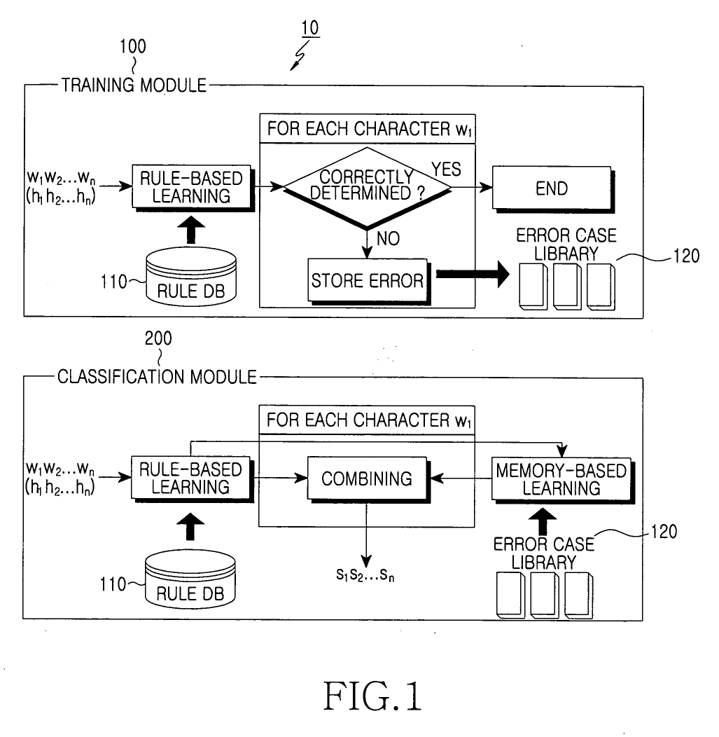

Hereinafter, an automatic word spacing program for a short message in a mobile terminal according to the present invention will be described with reference to the accompanying drawings. As shown in FIG. 1, an automatic word spacing program 10, which employs the combination of a rule-based learning method and a memory-based learning method, includes a learning module 100 and a classification module 200. The learning module 10 creates a rule database 110 and an error case library 120 by using an input data set. The classification module 200 performs an automatic word spacing operation for a short message, by using the rule database 110 and error case library 120, which have been created by the learning module 100. Meanwhile, the classification module 200 is installed in a mobile terminal together with the rule database 110 and error case library 120, and performs an automatic word spacing operation with respect to a short message received by the mobile terminal before displaying the received short message through a display unit. Hereinafter, the construction and operation of the learning module 100 and classification module 200, which are included in the automatic word spacing program 10, will be described in detail.

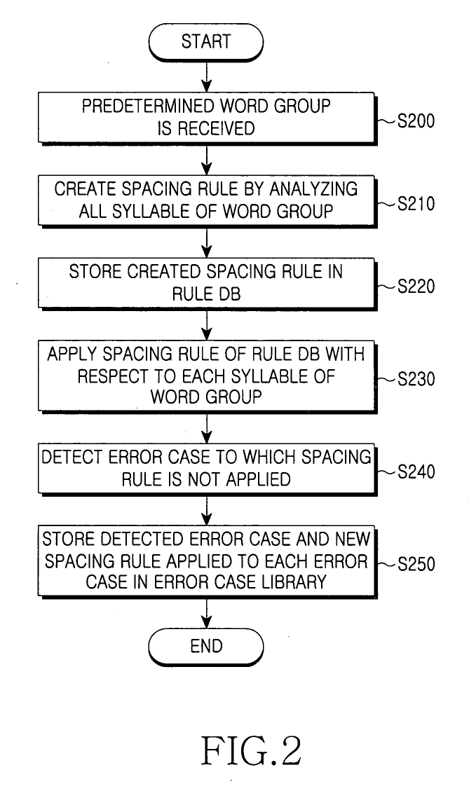

FIG. 2 is a flowchart illustrating the operation of the leaning module 100 included in the automatic word spacing program according to the present invention. Before being installed in a mobile terminal, the learning module 100 automatically creates the rule database 110, to which a rule-based learning model is applied, through a predetermined training procedure, and constructs the error case library 120 by applying a memory-based learning model based on the generated rule database. The procedure for creating a rule database and an error case library by the automatic word spacing program will now be described in detail with reference to FIG. 2.

First, the learning module receives a predetermined word group in step 200. In this case, the received word group corresponds to a word group for learning, in which word spacing is accurately kept. According to the present invention, news scripts from specific broadcasting stations are used as a word group. Next, the learning module creates word spacing rules applicable to the syllables by applying a rule-based learning model with respect to each syllable in the word group at step 210, and stores the created word spacing rules in the rule database at step 220.

After creating the rule database by using the word group in the above-mentioned step, the learning module applies the word spacing rules of the rule database with respect to each syllable in the word group at step 230. Then, the learning module detects error cases which correspond to exceptions of the word spacing rules of the rule database at step 240, and stores the detected error cases and new word spacing rules applied to the error cases in the error case library at step 250.

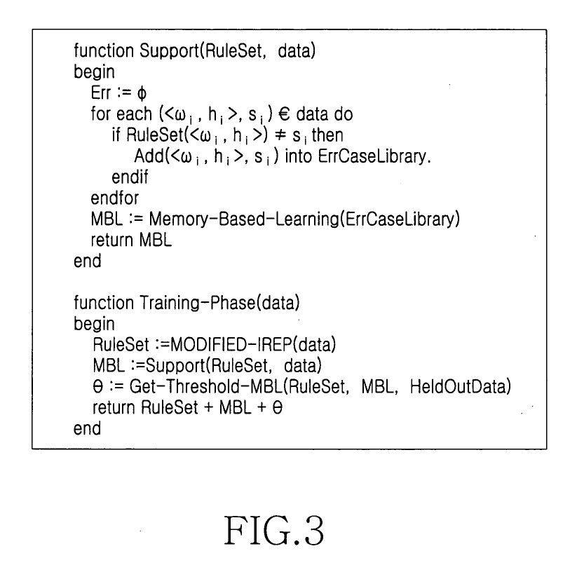

FIG. 3 illustrates a program obtained by coding the above-mentioned learning module, in which “w” represents one word, a short message “M” includes “n” number of words, and “hi” represents contexts of word “wi”.
M=w₁,w₂,w₃, . . . ,wₙ=h₁,h₂, . . . ,hₘ

It is noted from FIG. 3 that a Training-Phase (data) function is used for a procedure for creating both a rule database “RuleSet” and an error case library “MBL” by using a word group which is an input data set.

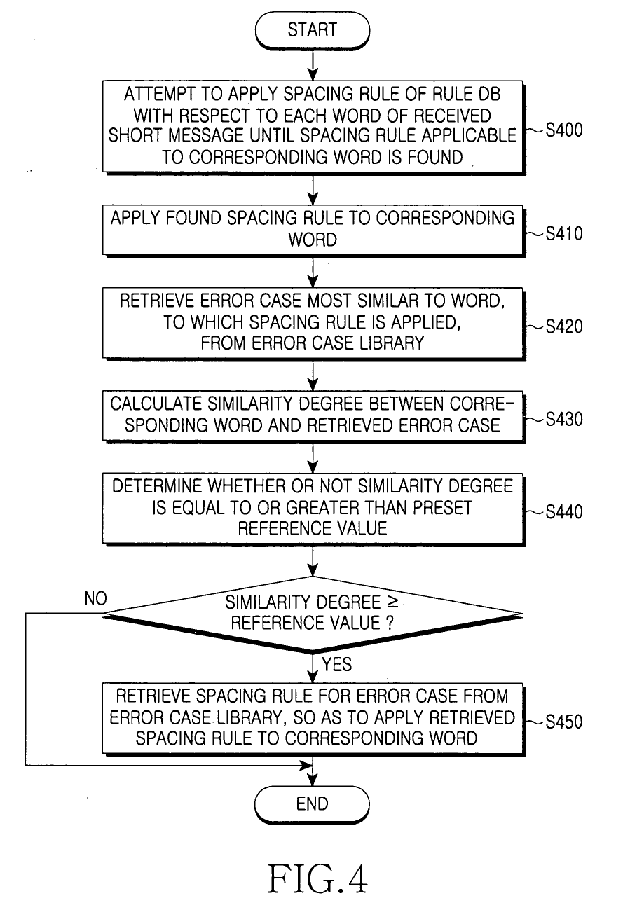

Hereinafter, the construction and operation of the classification module 200 will be described in detail with reference to the flowchart of FIG. 4, which illustrates the operation of the classification module in the automatic word spacing program 10 according to the present invention. The classification module 200 is installed in the mobile terminal together with the rule database 110 and the error case library 120, which have been created by the learning module 100, and automatically performs a word spacing operation with respect to a short message received by the mobile terminal. The operations of the automatic word spacing program will be sequentially described with reference to FIG. 4.

First, an attempt is made to apply the word spacing rules of the rule database one by one with respect to each word in a received short message at step 400. When a word spacing rule applicable to a corresponding word is found, the rule application procedure for the corresponding word ends, and that word spacing rule is applied to the corresponding word at step 410.

Next, an error case “y”, most similar to the corresponding word “x”, to which the word spacing rule is applied, is retrieved from the error case library at step 420. Then, a similarity degree “D(x,y)” between the corresponding word “x” and the retrieved error case “y” is computed at step 430, and it is determined if the similarity degree is equal to or greater than a preset reference value “θ” at step 440. When the similarity degree is equal to or greater than the preset reference value, a word spacing rule for the error case is retrieved from the error case library, and the retrieved word spacing rule is applied to the corresponding word at step 450.

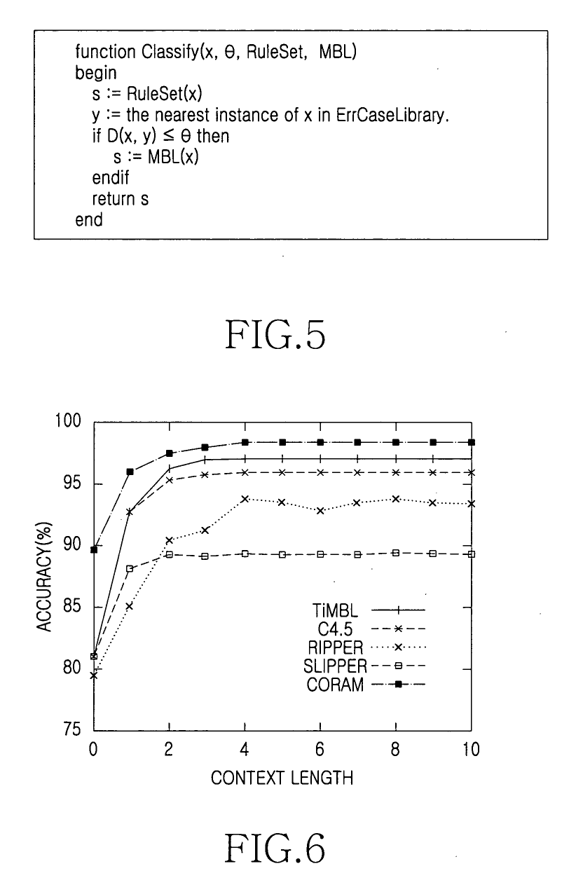

FIG. 5 illustrates a program obtained by coding the above-mentioned classification module, in which a Classify (x, θ, RuleSet, MBL) function performs automatic word spacing with respect to an input “x”.

When the above-mentioned procedure is performed with respect to each word in a short message, it is possible to modify a short message in which proper word spacing has not been adopted to a short message to which exact word spacing is applied, thereby outputting the corrected short message to a display unit of a mobile terminal.

In the classification model of the automatic word spacing program according to the present invention, it is very important to determine whether to apply a rule-based classifier or memory-based classifier. To this end, according to the present invention, a similarity degree “D (x,y)” is calculated, and it is determined whether a rule-based classifier or memory-based classifier is applied according to whether the similarity degree is equal to or greater than a preset reference value “θ”. Therefore, when a similarity degree is equal to or greater than the preset reference value, a corresponding word is recognized as an exception to the rules, so that the memory-based classifier is applied the thereto. In contrast, when a similarity degree is less than the preset reference value, the rule-based classifier is applied to the corresponding word.

Hereinafter, the procedure for setting a reference value “θ” by the classification module in the automatic word spacing method according to the present invention will be described. An optimum value for the reference value is determined by using an independent held-out data set. Various values “θ” are applied to the Classify function shown in FIG. 5, and then a value that outputs the best performance of the held-out data set is determined to be an optimum reference value.

Hereinafter, the procedure for calculating a similarity degree “D (x,y)” by the classification module in the automatic word spacing method according to the present invention will be described.

First, a given example “x” includes x1, x2, . . . , xm, and the most similar example thereto is “y”. In this case, the “y” may be expressed as Equation 1, and “D (x,y)’ is defined as Equation 2.

$$\begin{matrix}y = {arg min}_{{y}_{i} ∈ ErrCaseLibrary} D ( x , {y}_{i} ) & ( 1 ) \\ D ( x , {y}_{i} ) = \frac{1}{{\sum }_{j = 1}^{m} {α}_{j} δ ( {x}_{j} , {y}_{ij} )} & ( 2 )\end{matrix}$$

Herein, “αⱼ” represents the weight of a j^{th} attribute, which is determined by an information gain, and “δ(xⱼ, yⱼ)” is as follows:

$$δ ( {x}_{j} , {y}_{j} ) = \{ \begin{matrix}1 if {x}_{j} = {y}_{j} , \\ 0 if {x}_{j} \neq {y}_{{}_{j}} .\end{matrix}$$

The information gain is defined as Equation 3 (see R. Quinlan, “Learning Logical Definition from Relation,” Machine Learning, Vol. 5, No. 3, pp. 239-266, 1990).

$$Gain ( S , A ) = Entropy ( S ) - {\sum }_{v ∈ Values ( A )} \frac{\vert {S}_{v} \vert}{S} Entropy ( S ) \\ Entropy ( S ) = {\sum }_{i = 1}^{c} - {p}_{i} log {p}_{i} \qquad ( 3 )$$

Herein, “S” represents the entire data set, “A” represents a j^{th} attribute, and “Values (A)” represents a set of values which attribute “A” can have. Also, “c” represents the number of classes which are included in the “S”, and “pᵢ” represents a probability of class “i” in the “S”.

Hereinafter, the effect of the automatic word spacing program according to the present invention will be described with the experiment's results.

First, since there is no standardized conversation data for Korean, an embodiment of the present invention uses television news scripts of three Korean broadcasting stations as a data set. Such a data set is a part of “Korean Information Base” distributed by the KAIST KORTERM (see the web site of http://www.korterm.org). Television news scripts are more similar to spoken language than newspaper scripts, which is the reason why television news scripts are adopted for the present test.

Table 1 shows brief statistics for a data set. The news scripts of KBS and SBS among the Korean broadcasting stations are used to train a model proposed by the present invention, and the news scripts of MBC are used as a test set. Since the proposed model requires a held-out set independent from a training set, 80% of the news scripts of KBS and SBS are used as the training set while the remaining 20% thereof are used as the held-out set. The number of words in the training set is 56,200, the number of words in the held-out set is 14,047, and the number of words in the test set is 24,128.

Since each word includes a plurality of syllables, the number of usage examples is much greater than the number of words. The number of examples for training is 234,004, the number of examples for held-out is 58,614, and the number of examples for test is 91,250. In addition, the number of usage syllables is only 1,284.

TABLE 1

| | No. of Words | No. of Examples |
|---|---|---|
| Training (KBS + SBS) | 56,200 | 234,004 |
| Held-Out (KBS + SBS) | 14,047 | 58,614 |
| Test (MBC) | 24,128 | 91,250 |

In order to estimate the performance of the program according to the present invention, the test results of the present invention were compared with those of RIPPER (see W. Cohen, “Fast Effective Rule Induction,” In Proceedings of the 12th International Conference on Machine Learning, pp. 115-123, 1995), SLIPPER (see W. Cohen and Y. Singer, “A Simple, Fast, and Effective Rule Learner,” In Proceedings of the 16th National Conference on Artificial Intelligence, pp. 335-342, 1999), C4.5 (see R. Quinlan, C4.5: Programs for Machine Learning, Morgan Kaufmann Publisher, 1993), and TiMBL (see W. Daelemans, J. Zavrel, K. Sloot, and A. Bosch, TiMBL: Tilburg Memory Based Learner, version 4.1, Reference Guide, ILK 01-04, Tilburg University, 2001). Herein, RIPPER, SLIPPER, and C4.5 are rule-based learning algorithms, and TiMBL is a memory-based learning algorithm. Table 2 shows an experiment's result.

TABLE 2

| Data Set | Accuracy |
|---|---|
| C4.5 | 92.2% |
| TiMBL | 90.6% |
| RIPPER | 85.3% |
| CORAM | 96.8% |

As shown in Table 2, the rule-based learning algorithm shows better performance than the memory-based learning algorithm. Therefore, RIPPER shows the lowest accuracy, and C4.5 and TiMBL show accuracy of about 90%. However, the CORAM (Combination of Rule-based learning And Memory-based learning) algorithm according to the present invention shows accuracy of 96.8%. The accuracy of 96.8% is the highest accuracy, which is 4.6% higher than that of the C4.5, 11.5% higher than that of RIPPER, and 6.2% higher than that of TiMBL. Therefore, it can be understood that the CORAM algorithm, according to the present invention, shows higher performance than the rule-based learning and memory-based learning algorithms.

Hereinafter, the reason why the algorithm according to the present invention has the highest accuracy will be described. Among 91,250 examples in the test set, 67,122 examples belong to a non-split class (i.e. non-spacing class), and the remaining examples belong to a split class (i.e. spacing class). As a result, the lowest boundary is “67122/91250×100”, that is, 73.6%. As described above, the algorithm according to the present invention employs both the learning algorithms. The accuracy of the modified rule-based learning algorithm (modified-IREP) is 84.5%, and the accuracy of the memory-based learning algorithm is only 38.3%. However, the probability that any one of the two algorithms can predict exact classification is 99.6%. That is, the maximum value of the accuracy is 99.6%. Accordingly, accuracy may be a value between 73.6% and 99.6%. The accuracy of CORAM is 96.8% as shown in Table 2, which means that the accuracy of CORAM is very close to the maximum value of the accuracy. FIG. 6 is a graph illustrating the accuracies of algorithms as a function of context lengths.

Hereinafter, the reason why the accuracy of MBL is very low in spite of the fact that the accuracy of TiMBL is relatively higher will be described. MBL, which is the memory-based classifier of the algorithm according to the present invention, is trained only by the error case library. The modified rule-based learning algorithm (modified-IREP) shows very high accuracy, in which just 36,270 errors occur. These errors correspond to exceptions to the rules, which cannot solve all examples (i.e. all instance spaces). As a result, although TiMBL is very general, a hypothesis obtained by the memory-based learning using these errors is not general.

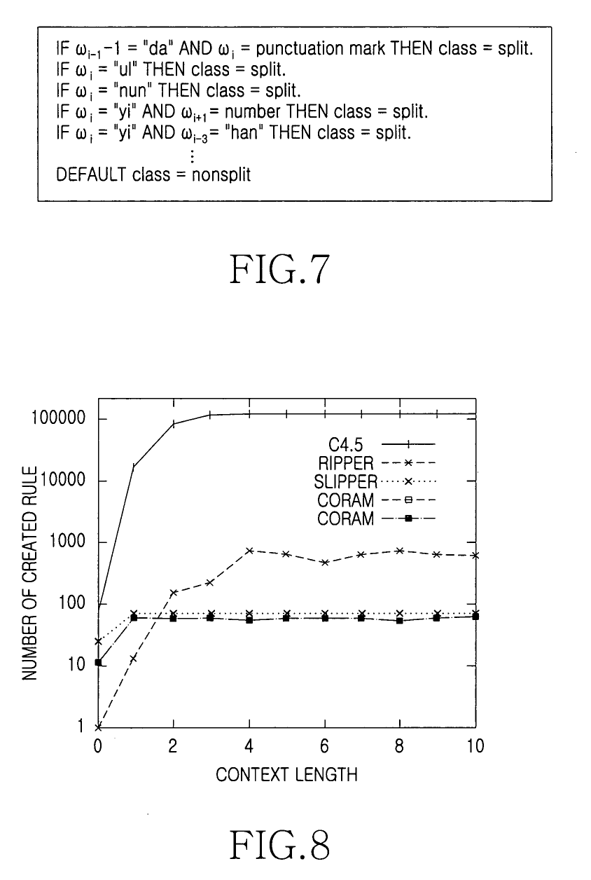

FIG. 7 illustrates examples of rules for Korean, which are learned by the modified-IREP. Although nine syllables (i.e. one syllable for “wi” and eight syllables for “hi”) exist with respect to each example, each created rule includes only one or two antecedents. In addition, the modified-IREP creates only 179 rules. Differently from the modified-IREP, C4.5 creates 3 million rules or more. In brief, the algorithm according to the present invention has a small number of simple rules, so that it is possible to rapidly process examples which are not classified by the rules. Accordingly, the algorithm according to the present invention is suitable for devices which have a small-quantity memory and a limited calculation capability. In addition, the algorithm according to the present invention is reinforced with the memory-based classifier, thereby providing greater accuracy. FIG. 8 is a graph illustrating the number of rules created according to the algorithms as a function of context lengths.

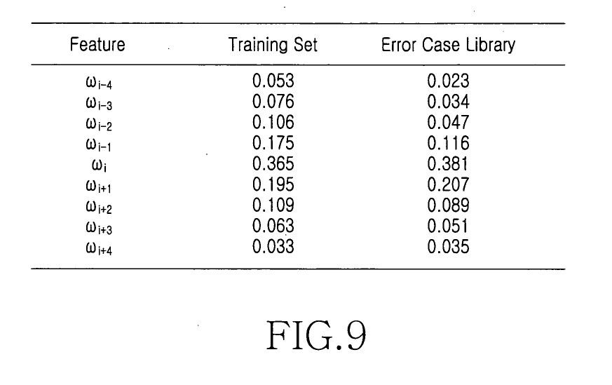

FIG. 9 illustrates information gains of nine syllables with respect to a training set and an error case library. Referring to FIG. 9, it can be understood that “wᵢ” is the most important syllable for both sets in determining “sᵢ”. The second important syllable is “wᵢ₊₁”. The least important syllable in the training set is “wᵢ₊₄”, and the least important syllable in the error case library is “wᵢ₋₄”. Consequently, as a syllable is spaced further from the “wᵢ”, the syllable is less important in determining “sᵢ”.

The automatic word spacing program according to the present invention, which employs the combination of the rule-based learning and memory-based learning algorithms, can be applied to devices having a small-quantity memory. According to the automatic word spacing program of the present invention, first, rules are learned, and memory-based learning is performed together with the error cases of the trained rules. In classification, it is based on the rules in principle, and its estimate is verified by a memory-based classifier. Since the memory-based learning is an efficient method to handle exceptional cases of the rules, it supports the rules by determining the exceptional cases to the rules. That is, the memory-based learning enhances the trained rules by efficiently handling their exceptional cases.

As described above, the algorithm according to the present invention is much more efficient than a rule-based learning algorithm or memory-based learning algorithm alone. Accordingly, the automatic word spacing program for a short message according to the present invention can be efficiently used in devices, such as mobile terminals, which have a small-quantity memory and a limited calculation capability.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the following claims and the equivalents thereof.

What is claimed is:

1. A recording medium comprising:
a rule database for storing word spacing rules which are applied to each word included in a short message;
an error case library for storing error cases, to which the word spacing rules of the rule database are not applied, and word spacing rules to be applied to the error cases; and
an automatic word spacing program for a short message, the program performing an automatic word spacing operation with respect to each word of a received short message by using the rule database and the error case library,
wherein the automatic word spacing program for a short message includes a method to be sequentially executed for each word included in the short message, the method comprising the steps of:
a) attempting to apply the word spacing rules of the rule database in order with respect to each word of the short message until a word spacing rule applicable to a corresponding word is found;
b) applying the word spacing rule found from the rule database to the corresponding word;
c) retrieving an error case most similar to the corresponding word, to which the word spacing rule has been applied, from the error case library;
d) calculating a similarity degree between the corresponding word and the retrieved error case; and
e) retrieving a word spacing rule corresponding to the error case with respect to the corresponding word from the error case library when the similarity degree is equal to or greater than a predetermined reference value, and applying the retrieved word spacing rule to the corresponding word.

2. The recording medium as claimed in claim 1, wherein the similarity degree is calculated by:
$$D ( x , {y}_{i} ) = \frac{1}{{\sum }_{j = 1}^{m} {α}_{j} δ ( {x}_{j} , {y}_{ij} )} ,$$
wherein “x” represents an input short message, “y” represents an error case, “αⱼ” represents the weight of a j^{th} attribute, which is determined by an information gain, and
$$δ ( {x}_{j} , {y}_{j} ) = \{ \begin{matrix}1 if {x}_{j} = {y}_{j} , \\ 0 if {x}_{j} \neq {y}_{{y}_{j}} .\end{matrix}$$

3. The recording medium as claimed in claim 1, wherein the reference value is determined by using an independent held-out data set.

4. The recording medium as claimed in claim 1, wherein the recording medium is installed in a mobile terminal so as to perform an automatic word spacing operation with respect to a short message received by the mobile terminal and then to display the short message on a display unit.

5. A recording medium for recording an automatic word spacing program, the recording medium comprising:
a learning module for creating word spacing rules using a predetermined word group, creating a rule database for storing the created rules, and constructing an error case library by extracting an error case by using the rule database and creating a word spacing rule to be applied to each error case; and
a classification module for performing an automatic word spacing operation with respect to a series of words by using the rule database and error case library, which are created by the learning module.

6. The recording medium as claimed in claim 5, wherein the classification module sequentially performs the steps of:
attempting to apply the word spacing rules of the rule database in order with respect to each word in a series of words until a word spacing rule applicable to each word is found;
applying a word spacing rule found from the rule database to a corresponding word;
extracting an error case most similar to the corresponding word from the error case library;
calculating a similarity degree between the corresponding word and the extracted error case; and
retrieving a word spacing rule corresponding to the error case from the error case library when the similarity degree is equal to or greater than a predetermined reference value, and applying the retrieved word spacing rule to the corresponding word.
